(19) United States
(12) Patent Application Publication
(10) Pub. No.: US 2023/0114560 A1
(43) Pub. Date: Apr. 13, 2023

(54) System and Methods for Recovery of Legal Damages Across Borders

(71) Applicant: David Elmo Purinton, (US)

(72) Inventor: David Elmo Purinton, (US)

(21) Appl. No.: 17/498,006

(22) Filed: Oct. 11, 2021

(51) Int. Cl. G06Q 50/18; G06Q 30/06; G06Q 20/38

(52) U.S. Cl. CPC G06Q 50/18; G06Q 30/0645; G06Q 20/389

(57) ABSTRACT

An integrated system and method geared toward aiding the rental industry in recovery of damage losses from U.S. Nationals who rent abroad.

### II. CROSS-REFERENCE TO RELATED APPLICATIONS

This application claims priority to Utility patent application Ser. No. 14/250,593 filed by same inventor on Apr. 11, 2014 in turn claiming priority to Provisional Patent Application 61/811,606 filed by same inventor on Apr. 12, 2013.

### III. STATEMENT REGARDING FEDERALLY SPONSORED RESEARCH OR DEVELOPMENT

Not applicable

### IV. REFERENCE TO SEQUENCE LISTING, A TABLE, OR A COMPUTER PROGRAM LISTING COMPACT DISC APPENDIX

Not Applicable

### V. BACKGROUND OF THE INVENTION

The Field of the invention is recovery of money damages in civil law suit situations, where conflicts of laws, forum selection, and choice of law are at issue. Resolution of damage claims in the rental business, for recovery from individuals who rent abroad, has particular nuances that require specialized systems and processes which are installed, organized, and performed in particular sequences, so that damage claimants may be able to reach reasonable fair and just resolution for recovery of damages from the tortfeasors (Respondents) who are United States Citizens, upon their return to the United States. Historically, rental companies would have to obtain payment for damages from the renter prior to them leaving the country where rented. Collection actions have been pursued, but may have resulted in dead end recovery paths because there was no jurisdiction in the country where the damage occurrence took place. Forum and choice of law clauses, assigning jurisdiction or venue to courts or alternative dispute resolution forums such as mediation or arbitration, have been used extensively and often found enforceable by United States Courts of jurisdiction. e.g. Bremen v. Zapata Off-Shore Co., 407 U.S. 1 (1972).

### VI. BRIEF SUMMARY OF THE INVENTION

A person (individual or corporate entity, hereafter “Claims Administrator”) in the United States enters into an assignment agreement (“Administrative Assignment”) with a rental agency in a foreign country (hereafter “Rental Agent”) whereby the Rental Agent agrees to have said Claims Administrator handle recovery of damage claims for rented vehicles, equipment, or other rental goods, products, or commodities (“Rental”) if and when the Rental is damaged while in the custody and control of a United States Citizen (hereafter “Citizen”) while renting in the foreign country.

When said Citizen travels to a foreign country and reserves or otherwise requests said Rental, the Rental Agent requires the Citizen to sign an additional agreement (“Addendum”) which through binding agreement contains language (hereafter “Clause”) which assigns all claims (“Claims Assignment”)for damages, occurring during said Rental, to said Claims Administrator.

Citizen is asked to declare, at time of Rental, Citizen's home state (“State”) of international boundary along with address, phone number, and any other identifying information which will aid in contacting said Citizen in the United States. Proof of identification such as Driver's License, Credit Card, Bank Account, or other proof can be obtained from Citizen by Rental Agent.

Said Clause is generated based on said Citizen Declaration and a forum choice, choice of law, and assignment of claims is made by Citizen through expressed agreement, which in a preferred embodiment, chooses the Citizen's home state as the forum and choice of law for administration or litigation of any damages or recovery of costs for any damage.

Said Clause Rental Agent's standard terms and conditions of Rental are generated based on Rental Agent's contract with said Citizen and then added (or incorporated by reference) into said Addendum. In the event of damage to said Rental, when said damage is reported or discovered, Rental Agent attempts to notify (or otherwise remind) said Citizen of the terms of the Addendum. After said damage is reported or discovered, Rental Agent attempts to notify (or otherwise report) said damage to said Claims Administrator in the United States.

Claims Administrator in the United States may then send notification to Citizen at the mailing address obtained during the reservation or Rental. Upon Citizen's return to the United States Claims Administrator may continue to contact Citizen by any means of communication available or prudent to attempt to settle the damage claim.

If damage claim is disputed by Citizen, Claims Administrator may utilize any and all non-judicial actions and remedies as allowed in the State of international boundary. If non-judicial actions and remedies do not result in recovery to the Claims Administrator's or Rental Agents satisfaction, Claims Administrator may resort to judicial action.

### VII. BRIEF DESCRIPTION OF THE DRAWING

A citizen from one country, nation, region, or political boundary may travel abroad to a foreign country with a travel visa (“stamp”) and passport. The Drawing depicts travel to four different continents. At the time of filing this application, there are approximately 196 sovereign states or territories in the world which are recognized as separate countries. Political entities in the world are subject to change in numbers and boundaries. It is contemplated that this use of this invention is effectual for any U.S. born or naturalized citizen. Travel to any country is an intended embodiment of this invention.

### VIII. DETAILED DESCRIPTION OF THE DRAWING

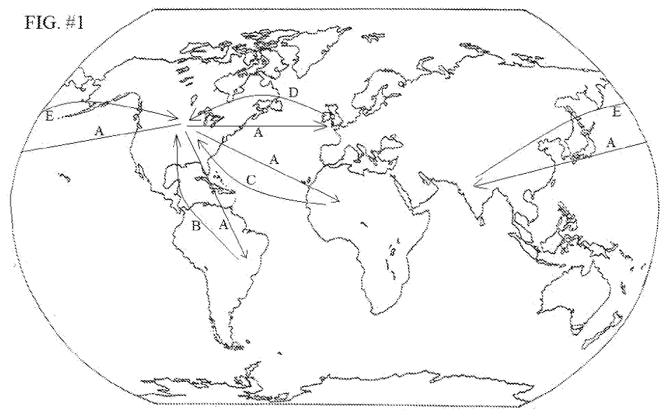

FIG. 1
1. Assignment-Addendum package, A, is a multi-generated custom addendum, in several versions, depending on the Rental Agent's rental contract requirements, and the laws of the country, province, municipality, etc. according to the method and system form generator.
2. In a preferred embodiment the Assignment-Addendum package includes the Administrative Assignment and Claims Assignments with required Addendum language customized for the Rental Agent's contract and country. Other piece meal packages are expected and likely.
3. In a preferred embodiment, the Addendum forms are generated and transmitted in real-time via electronic communication, but in other embodiments the forms are pre-generated in bulk and delivered on hard paper, periodically, to a foreign Rental Agent.
4. In yet other embodiments instructions are given and the Rental Agent generates the Assignment-Addendum package.
5. In a preferred embodiment the Administrative Assignment portion of the Assignment-Addendum package is done once per year or other periodic intervals.
6. In a preferred embodiment, the Claims Assignment portion of the Assignment-Addendum package is custom generated for each Citizen Rental. In yet other embodiments, the Assignment-Addendum package is generated, pre-generated, or copied and mailed to the Rental Agent, piece meal, or in any order or sequence and via any means of sending or transmitting.
7. In a preferred embodiment, the Rental Agent transmits the Citizen signed and executed Addendum and a customized notice (B,C,D,E) via electronic means to the Claims Administrator in the united States as soon as damage is reported or discovered.

### IX. DETAILED DESCRIPTION OF THE INVENTION

a. Long Felt Need

There has been a long felt need in the vehicle rental industry for a mechanism for recovery of damage claims to U.S. citizens who travel to another country. This invention is the subject of a United States patent application, but contemplates travel from or to anywhere in the world. United States law allows for forum selection and choice of law in a contract. Many other countries have laws which also support forum selection and choice of law in a contract.

Current global Economies depend on international contracts, such as when one contracting party is from one country and the other contracting party(ies) is/are from another country. It is not only possible, but quite probable, in today's fast-paced and highly available modes transportation and communication, that parties entering a contract for goods or services will be from different countries. The rental contract produces a unique twist on the international contract. A company based in the United States, for example may have a foreign entity. For example, U.S. companies like Hertz, Avis, or Enterprise are understood to have entities in foreign nations. In this context in the remainder of this application the rental company is referred to as the “Foreign” company and the U.S. Parent (or third party assignee) as the “Parent.”

In situations where the traveler is coming from the United States, very often the reservation for the rental vehicle is made in the United States before the traveler even leaves their home country. This initial negotiation therefore often involves both U.S. travel agents with another U.S. company, but the actual contracting party often turns out to be the U.S. company's Foreign subsidiary. The forum selection clause is an often an overlooked issue as to the rental contract because the vehicle will be both rented and used in the foreign county. But, when damage occurs, very often the person simply returns the car (both during and after hours) to the rental location usually at or adjacent to the international airport and then simply boards the airplane conveniently returning to the United States. The Foreign subsidiary may attempt a “forced charge” to the renter's credit card for the damage, but such charges are easily reversed by the renter and the Foreign rental company has very little recourse in seeking to enforce the foreign signed contract.

Forum selection and choice of law contractual terms are of great importance when a dispute arises between parties and often may be the first items litigated in courts. Forum selection sets the terms for where the litigation will take place and choice of law will set the terms for what substantive law will be followed by the court. This invention addresses specifically international forum selection and choice of law clauses.

b. Local Variations to the Rental Contract/Addendum

In one embodiment, the underlying rental contract might require the renter to enter into a separate contract with the home rental company. In the drawing we use the United States as the example location of the “home” corporation. In consideration for the rental, the foreign rental company or subsidiary will require that an addendum to the rental contract must be signed by the renter which will supersede anything to the contrary in the local rental agreement. This language is prominently identified in the rental contract and brought to the renter's attention. Specifically the addendum states that U.S. Parent or third party assignee (“Parent”) and the renter are the parties to the contract. It is important to note that Parent may include a U.S. Parent Company, third party assignee in the U.S., a local entity in country where the rental takes place, or any combination of one or more entities. In some embodiments the third party assignee may also be preferred depending on Foreign law in the place where the vehicle is rented and the home country of the Parent.

Depending on laws in the Foreign state, the Parent may have to be included on the agreement as a separate signatory. This could present some difficulty if the local rental company has no agency for which to locally sign such an agreement. In this embodiment, there is also a separate “assignment” agreement that takes place between the Parent and the Foreign rental company, which makes the foreign rental company the agent of the U.S. Parent (or third party assignee).

In another embodiment, some countries have social and economic systems which are characterized by government ownership of the means of production. These are sometimes called socialistic, but most of these countries have variant forms of co-operative management economies. Many of these countries have a ministry within the government which must approve any consumer contracts entered into within its territories. Often these local laws only require such approval for contracts with its “citizens.” In other countries the government must in one way or another approve any and all forms of consumer contracts. In such countries, however, the prospect of recovery from non-citizens for damages they cause while in the country are advantageous to its citizens and getting approval for such a contract should not prove to be overly difficult.

Many forms of government for where the local contract is entered are contemplated, including by not limited to dictatorships, socialist states, monarchies, democracies, republics, and others. The law of the “home” country is most important to the enforceability of the contract. The country or state which is the home state of the renter is important to whether or not the country or state allows for forum selection and choice of law. In the United States, the courts have supported both forum selection and choice of law.

c. Elements Common to many Forum Selection and Choice of Law Clauses

Enforceability of forum selection and choice of law clause will often be dependent on each other. Where a contract contains an enforceable forum selection clause, the choice of law clause will normally also be enforced. For example, the Supreme Court of the United States reasoned in M/S Bremen v Zapata Off-Shore Co 407 US 1 (1972)., “[w]e cannot have trade and commerce in world markets and international waters exclusively on our terms, governed by our laws and resolved in our courts.” Thus in the preferred embodiment where the “home” country of the traveler is the United States, two key elements are the forum selection and the choice of law clause. One or the other may suffice, but having both clauses is preferred.

The forum selection and choice of law may be included in the rental contract, but in the preferred embodiment, it is a separate addendum only for renters who reside in the home country. U.S. Courts will often differentiate between “required” or “permissive” forum selection and choice of law. A permissive forum clause confers jurisdiction in the forum listed, but does not specifically prohibit party from litigating in another appropriate forum. In this preferred embodiment, the home country is in the United States of America and the clauses are intended to require action be brought in the specified forum. Below is a sample addendum. This is intended to provide an example in a preferred embodiment, but in no way limits this invention to only this form of contract:

A second ingredient in the preferred embodiment is the agency/recovery agreement between the U.S. Parent and the Foreign rental company. This is the agreement that creates the agency for the Foreign rental company to bind the U.S. parent in the agreement between the renter and the U.S. parent company. Note that different laws in different countries may require other rights and responsibilities of parties. Any prosecution or litigation of those rights and responsibilities may sometimes require completely different roles or assignments. This below contractual text is intended to provide an example in a preferred embodiment, but in no way limits this invention to only this form of contract:

1. A forms processing system to facilitate on-demand transportation, comprising
a database storing on-demand for-hire transportation data;
a central processing unit (CPU) for determining a first international boundary and a second international boundary, wherein the first international boundary is associated with a location of an on-demand transportation object and a second international boundary is associated with a user of the on-demand transportation object;
a point-of-sale user interface including:
a physical output that displays printed readable characters to a first postulant within said first international boundary;
a physical input that electronically captures selection and declination data generated choice from said printed readable characters when viewed and chosen by said first postulant within said first international boundary;
a data input connection, wherein said point-of-sale user interface receives, via the data input connection, a subset of the international boundary data and the said selection and declination data;
a data storage unit that stores data generated by said point-of-sale user interface handler; and
a physical output that provides a display for transmitting or printing that includes:
printable characters on a substrate material, wherein the output is based on the subset of the determined first international boundary and second international boundary.

2. The system in claim 1 further comprising:
an electronic printer including:
a physical input that feeds a substrate material into the electronic printer,
a data input connection, wherein the printer receives via the data input connection, a
subset of the international boundary data.

3. The system in claim 1 further comprising:
an electronic scanner with optical character recognition capability.

4. The system in claim 1 further comprising:
an electronic touchpad with electronic signature capture.

5. The system in claim 1 further comprising:
a plurality of fixed position physical transportation points-of-sale with fixed position user interface devices on or in said fixed position physical transportation points-of-sale counters;
wherein said fixed position transportation points-of-sale counters are geopositioned in various locations throughout the world with each fixed position device on or in said fixed position points-of-sale counters configured to communicate via electronic signal transmission with at least one of a plurality of fixed position claims administrator devices geopositioned in various locations throughout the world is physically remote from said fixed position physical transportation points-of-sale counters' geopositions;
wherein residency data is input and stored on said fixed position physical points-of-sale counters with fixed position devices and said residency data is transmitted over a communication link to one or more of said fixed position claims administrator devices;
wherein one or more of said fixed position claims administrator devices is programmed to calculate on one or more CPUs or to receive a calculation from automated fixed position physical transportation point-of-sale counters with fixed position devices, court jurisdictional information in real-time; and
wherein a point-of-sale record from at least one of said fixed position transportation points-of-sale counters calculating with a CPU is printed or displayed in real-time to establish which political boundary is associated to said point-of-sale record and which choice of court jurisdiction is appropriate to said residency data.

6. A method for printing and processing residency data into sequential business forms across political boundaries comprising:
inputting political boundary data into a Central Processing Unit (CPU) through a user interface;
inputting first postulant international boundary data into a serialization database;
inputting second postulant international boundary data into a serialization database;
inputting third postulant international boundary data into a serialization database;
feeding paper materials into to an electronic printer,
transmitting said first postulant international boundary data to said electronic printer in electronic format for processing as a document;
controlling said electronic printer to print readable characters on a display of one or more damage claims from a first postulant who resides within a first international political boundary, wherein the first postulant rents itemized goods, property or equipment to a second postulant, wherein the second postulant resides within the second international political boundary, travels to a location within the first international political boundary, and rents the itemized goods, property or equipment, located within the first international political boundary, from the first postulant, and wherein the itemized goods, property or equipment are damaged while being rented;
printing said readable characters on a display from serialized data transmitted from within said second international political boundary to a location within said first political boundary by calculating with said CPU which political boundary said second postulant resides.

7. The method according to claim 6, further comprising: inputting geographical court jurisdictional data into a Central Processing Unit (CPU).

8. The method according to claim 6, further comprising: calculating a non-excluded jurisdiction with said CPU within said political boundary where said second postulant resides.

9. A method for processing transportation for hire point-of-sale forms comprising:
Receiving as a third postulant residing within a second international political boundary, display via user interface of one or more damage claims from a first postulant who resides within a first international political boundary, wherein the first postulant rents itemized goods, property or equipment to a second postulant, wherein the second postulant resides within the second international political boundary, travels to a location within the first international political boundary, and rents the itemized goods, property or equipment, located within the first international political boundary, from the first postulant, and wherein the itemized goods, property or equipment are damaged while being rented;
obtaining, via real-time, electronic communication, a record that the second postulant resides within the second international political boundary based on a physical presentation of international travel admittance associated with the second postulant;
generating and transmitting a package of forms with citizen signatories, residency, forum selection, and choice of law to the second postulant who, by provision is subject to legal process, by the third postulant, within the second international political boundary for recovery of damage to the itemized goods, property or equipment, wherein the second postulant, at a time of choosing the itemized goods, property or equipment, resides within the second international political boundary;
receiving, from the second postulant, a signatory action associated with the package of forms, wherein the signatory action received within the first international political boundary is performed by the second postulant;
sending, subsequent to receiving the signatory action associated with the package of forms from the second postulant, the package of forms with the citizen signatories, residency, forum selection, and choice of law to the second postulant within the second international political boundary after the second postulant travels back to a location within the second international boundary; and
processing recovery documents, by the third postulant, payment of damages within the second international political boundary after the sending of the package of forms with the citizen signatories, residency, forum selection, and choice of law and the signatory action received from the second postulant within the first international political boundary to the second postulant while in the second international political boundary.

10. The method according to claim 9, further comprising:
receiving, by the third postulant, damage claim information from the first postulant concerning a damage incident which occurred during the period of time which the itemized goods, property or equipment were in the possession of the second postulant.

11. The method according to claim 9, further comprising:
receiving, by the third postulant, a contingency fee.

12. The method according to claim 9, wherein package of forms includes sequential data that third postulant resides within the second international political boundary.

13. The method according to claim 9, wherein package of forms includes terms binding the second postulant to submit to jurisdiction of courts within the second international political boundary.

14. The method according to claim 9, wherein package of forms includes terms binding the second postulant to submit to any venue within said second international political boundary.

15. The method according to claim 9, wherein package of forms includes terms binding the second postulant to submit to arbitration in any venue within said second international political boundary.

16. The method according to claim 9, wherein the generating is performed in bulk and the transmitting includes delivery of hard copies to the first postulant.

17. The method according to claim 9 further comprising; sequential data identifying the first international political boundary and in the package of forms sequential data identifying the third postulant that resides in the second international political boundary as a claims Administrator where the laws of the country or state in the second international political boundary do not subject the second postulant to legal process by the third postulant for recovery of damage to the itemized goods, property or equipment.
